(19) United States
(12) Patent Application Publication
(10) Pub. No.: US 2023/0231636 A1
(43) Pub. Date: Jul. 20, 2023

(54) Method and Apparatus for Neighbor Interference Management in a Self-Organizing Neighborhood

(71) Applicant: Celona, Inc., Campbell, CA (US)

(72) Inventors: Srinivasan Balasubramanian, San Diego, CA (US); Sourav Bandyopadhyay, Campbell, CA (US); Shashideep Nuggehalli, Campbell, CA (US)

(21) Appl. No.: 18/153,748

(22) Filed: Jan. 12, 2023

Related U.S. Application Data
(60) Provisional application No. 63/298,939, filed on Jan. 12, 2022.

(51) Int. Cl. H04B 17/336; H04W 16/14

(52) U.S. Cl. CPC H04B 17/336; H04W 16/14

(57) ABSTRACT

Various embodiments of a method and apparatus for power management initiated from a Citizens Band radio Service Device (CBSD) are disclosed. In addition, methods and apparatus for extending concepts related to Self Organizing Networks (SONs) to support Self Organizing Neighborhoods (SONgs) are also disclosed. Still further, various embodiments are disclosed here that allow for managing frequency/channel/BW (bandwidth) allocation, power allocation on each channel and Physical Cell ID (PCI) selection.

### CLAIM OF PRIORITY TO PREVIOUSLY FILED PROVISIONAL APPLICATION-INCORPORATION BY REFERENCE

This non-provisional application claims priority to an earlier-filed provisional application number 63/298,939 filed Jan. 12, 2022, entitled “Method and Apparatus for Neighbor Interference Management in a Self Organizing Neighborhood” (ATTY DOCKET NO. CEL-070-PROV) and the provisional application number 63/298,939 filed Jan. 12, 2022, and all its contents, are hereby incorporated by reference herein as if set forth in full.

### BACKGROUND

### (1) Technical Field

The disclosed method and apparatus relate generally to communication systems. In particular, the disclosed method and apparatus relates to a method and apparatus for managing interference between neighboring transceivers of either telecommunications networks or private communications networks.

### (2) Background

In telecommunications, a phenomenon known as atmospheric ducting is a condition in which a horizontal layer in the lower atmosphere has vertical refractive index gradients that can guide radio signals to follow the curvature of the Earth. Signals following these “ducts” can experience less attenuation in the ducts than they otherwise would. In some instances, interference can occur between base stations/access points (BS/APs), such as gNodeBs (gNBs) of a 5^{th} Generation (5G) communications system, commonly referred to as New Radio (NR). For the purposes of this disclosure, a BS/AP is any wireless transmitter, receiver or transmitter that allows user equipment (UE) wireless access to a communication network. For example, interference can occur between gNBs that are far from each other, but between which there is an atmospheric duct that allows atmospheric duct interference in a time division duplex (TDD) network. Such interference may be: (1) reciprocal, in that both the transmit and receive paths are subject to the interference; (2) more likely to be present between BS/APs that are across a plain from one another, or that reside within a rural area; and (3) sensitive to weather conditions, such as temperature, humidity, etc.

In many instances, interference mitigation techniques for TDD-LTE (Long Term Evolution) systems are limited to using manual operation through an operation management system. In many instances, mitigation techniques cannot be implemented in time to prevent such interference. Similar concerns exist with respect to 5G NR systems. Accordingly, there is current a need for an interference mitigation technique that is reliable and efficient for preventing interference in an NR 5G network.

### SUMMARY

Various embodiments of a method and apparatus for power management initiated from a Citizens Band radio Service Device (CBSD). In addition, methods and apparatus for extending concepts related to Self Organizing Networks (SONs) to support Self Organizing Neighborhoods (SONgs). Still further, various embodiments are disclosed here that allow for managing frequency/channel/BW (bandwidth) allocation, power allocation on each channel and Physical Cell ID (PCI) selection.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of some of the components of a network operating in accordance with release 16 (Rel 16) of the relevant 3rd Generation Partnership Project (3GPP) 5th Generation (5G) standard regarding interference mitigation.

FIG. 2 is an illustration of the manner in which interference may be imposed upon a receiver by an aggressor.

FIG. 3 is an illustration of two solutions for RI mitigation proposed by Rel 16.

FIG. 4 is a simplified flowchart of events in accordance with some aspects of the disclosed method and apparatus.

FIG. 5 is an illustration of a call flow in accordance with some embodiments of the disclosed method and apparatus.

FIG. 6 is an illustration of a call flow for some embodiments of the disclosed method and apparatus.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

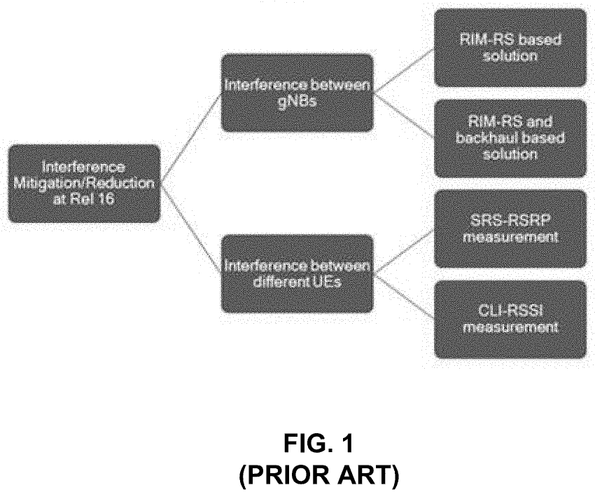

FIG. 1 is an illustration of some of the components of a network operating in accordance with release 16 (Rel 16) of the relevant 3^{rd} Generation Partnership Project (3GPP) 5^{th} Generation (5G) standard regarding interference mitigation. This industry standard provides techniques for mitigating interference between different eNodeBs (eNBs) that are located far from each other. In addition, interference between user equipment (UEs) that are near to each other and that have different up link and down link configurations are provided in Rel 16.

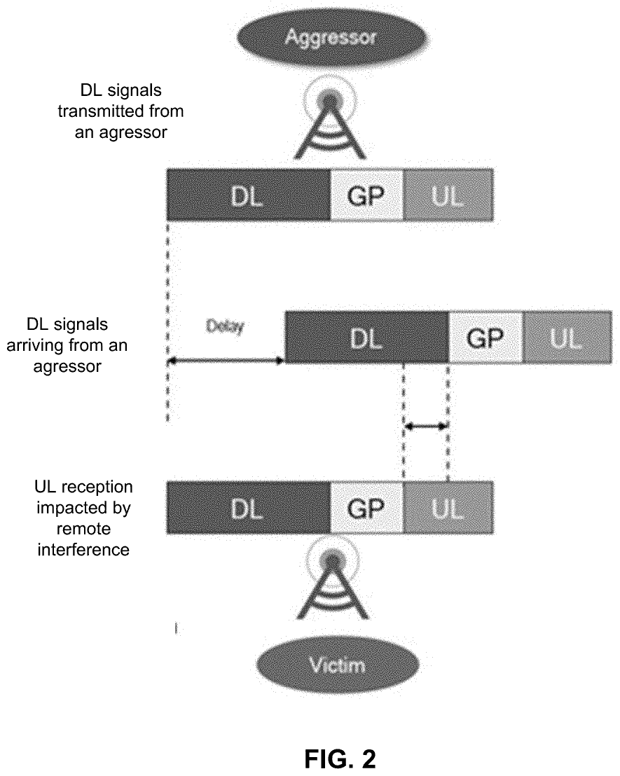

FIG. 2 is an illustration of the manner in which interference may be imposed upon a receiver by an aggressor. In a time division duplex (TDD) network, an agressor's downlink (DL) transmissions can travel large distances and interfere with a victims uplink (UL) reception despite a “guard period”. Such interference is sometimes referred to as remote interference (RI). The aggressor may be a gNB transmitting a DL signal. The victim may be a gNB where the UL signals are impacted by the remote DL signal from the aggressor. In this case, there is an assumption that the TDD network has a unique DL/UL configuration.

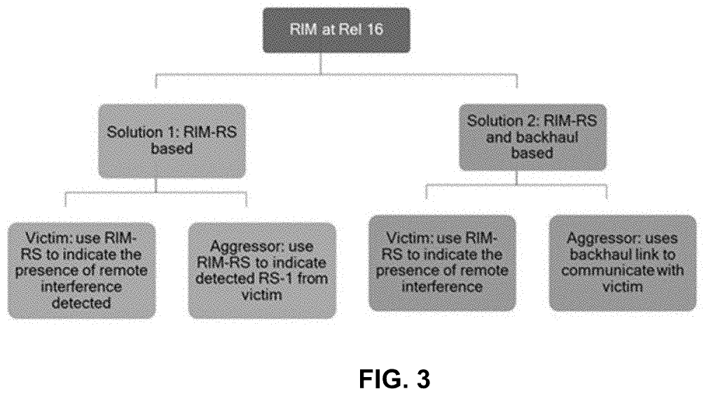

FIG. 3 is an illustration of two solutions for RI mitigation proposed by Rel 16. The first solution is RIM-RS (Remote Interference Management-Reference Signal) based, in which both the aggressor and the victim transmit/monitor RIM-RS. The second solution is RIM-RS and backhaul based in which only the victim transmits RIM-RS and the aggressor uses the backhaul via a 5GC (5G network core) to notify the victim.

In one embodiment of the presently disclosed method and apparatus, problems that are addressed include that a Spectrum Access System (SAS) coordinates operation across enterprise deployments that may be associated with one or more vendors. Such coordination requires extensive information of the radio environment to be provided. The time at which the information is captured is not coordinated, without which, it will be hard correlate the information received from the different CBSDs. Additionally, different CBSDs have differing capabilities. In some embodiments, REM can be performed only during power up or measurements can be done actively during regular operation. In some cases, receive sensitivity of the different devices vastly vary and there is no clear approach to calibrate the measurement information collected. Even when the information can be collected, it is possible that the enterprises restrict the information being shared with a central SAS entity due to the sensitivity of the information being shared.

### Neighbor Interference Management

A CBSD experiencing specific radio frequency (RF) conditions, requests changes in the neighborhood to SAS/CxM. These changes may include: (1) Frequency/Channel/BW assignment for the cells in the neighborhood; (2) Tx power level of the cells in the neighborhood, wherein the request can be to go up or down for all the cells in the neighborhood; (3) PCI assignment changes; (4) Usage pattern changes requiring the use of a different TDD configuration/channel assignment for the cells in the neighborhood.

In some embodiments, triggers for the change are initiated from CBSDs that are going through the actual experience in the field. This avoids sending of all the radio environment information to the SAS/CxM for a centralized control. This separates the conditions for trigger from the procedural detail of interactions with the SAS/CxM and the cells in the neighborhood to effect the change.

Furthermore, in some embodiments, a network/CBSD may request changes only when there are issues and improvement in the performance is desired. Once the trigger is initiated the request for change is assessed with the neighborhood cells. In some embodiments, cells that are fine with the current allocation can determine the impact of the changes requested. In some embodiments, rules for cooperation may be to be established (e.g., networks are designed to operate at a certain power level based on network planning and may not be willing to change which may be impacting the neighborhood operations).

In some embodiments, a SAS/CxM can arbitrate knowing information about the “victim” and “aggressor” based on the feedback received. The SAS/CxM check on the current operating conditions of all the cells in the neighborhood and each cell is requested to provide their measured metrics. In some embodiments, the measurement and reporting of these summary metrics are standardized, calibrated, and certified for each CBSD.

In some embodiments, it is possible for the request to be coalized in the Domain Proxy (DP) and a unified request presented across CBSDs in a given deployment to be reported to the SAS/CxM requesting a change.

It should be clear that the measured RF conditions can be either good or bad. The metrics for performance can be computed by several means and the determined values used to provide the reasoning and the extent and the type of change being requested with the SAS/CxM to be established with the cells in the neighborhood.

In some embodiments, UE based measurements on site are used. In some embodiments, this is used as a manual trigger through the orchestration layer based on the user experience of network administrator or specific users based on their location reporting issues in the network administrator. In some embodiments, active measurements of DL and UL performance are made at the CBSD. Scheduler metrics for DL and UL operations are also measured. Knowledge of the constitution of the UEs operating on the AP is determined. Also knowledge of the constitution of the UE associated with the CPE-CBSD. In some embodiments, a mix of TDD configuration use issues is present.

In some embodiments, the metrics and the methods used, the measured metrics levels when the CBSDs can trigger a request to the SAS/CxM along with the established reasoning and the extend of the change being requested are standardized and the individual CBSDs calibrated for a consistent behavior.

The CBSDs within Interference Coordination Group (ICG)/Common Channel Group (CCG) are treated similar to any other neighbor to determine if the power level needs to be adjusted based the request from the CBSD. This procedure subsumes both intra-frequency and inter-frequency aspects and is a generic request from a CBSD based on the interference for DL and UL operation experienced by the CBSD.

In some embodiments, an information exchanged can be initiated directly from the CBSD to DP. In some other embodiments, it can be initiated from the orchestration layers based on the experience seen in the deployment through manual actions from the network User Interface (UI).

The Informational Elements (IEs) sent from the CBSD/DP to SAS include: (1) Channel rebalancing request, which includes: (a) current channel of use; (b) Max BW desired; (c) Min BW required.

In some embodiments, channel of operation use can be managed using the Bandwidth Part (BWP) feature in 5G NR. BWP based spectrum allocation dynamically and the interactions with SA allows for a wider channel allocation while operationally restricting the segments to be supported as operable parts of the spectrum.

In some embodiments, in a power level change request, the actual transmit power level desired by the CBSD and its neighbors may be requested. In other embodiments, the delta change in power level both up/down is communicated to the SAS. In some embodiments, this is preferrable given that the actual power levels and the locations of the neighbor CBSD is not known to given CBSD apart from its own network.

### Addressing System Stability

Power change of the reference signal power is updated, since as that changes, the link budget may be affected. The SAS currently has control to set the specific power levels for each CBSD. In some embodiments, a trigger mechanism from the CBSD allows for the SAS to assess when to enforce such power levels on the CBSDs. In some embodiments, changing the power level in steps allows better management of the interference in the neighborhood.

In some embodiments, Power change is more granular rather than changing the reference signal power. For Long Term Evolution (LTE) networks, it can be a Pa change or can be managed on an RB basis. In some embodiments, this results in better frequency reuse across the neighborhood, which, however, will require a lot of control information to be exchanged between the cells. The choice of MCS being more aggressive or conservative will be a scheduler choice from the CBSD understanding the operating conditions in realtime.

### PCI Conflict Issue

In some embodiments, renumbering is triggered to avoid PCI use conflicts. CBSD registration provides PCI/Channel used to the SAS. The SAS has a database of PCIs on a channel basis. The SAS provides the PCIs that are active on each channel. With this information, the Self Organizing Network (SON) chooses an appropriate PCI for each CBSD.

### Mix of TDD Configuration Use Issues

In some embodiments, issues regarding mix of TDD configuration use is reported. A request is made to rebalance the channel allocation, a guard band requirement is determined, and channel separation for allocation is made based on the preferred TDD configuration of operation for the different CBSDs.

In some embodiments, the Rel-16 RIM procedure in the SAS process is integrated when a given ‘victim’ cell transmits the reference signal and that signal is received by the CBSD. The CBSD initiating the RIM-RS transmission and the CBSD receiving the RIM-RS both communicate the information to the SAS. This communication from the CBSD also includes the preferred power level settings per the above description. SAS acts as an arbiter to ensure this request for changing of the power is legitimate and follows the commands from the SAS. The SAS is either already aware of the neighborhood and can instruct the other CBSDs to alter the power levels. Otherwise, the SAS checks with the CBSDs in the neighborhood of the requesting CBSD to see of the change in power level is acceptable. Neighborhood CBSDs, when a power change request is received, determine, based on the below metrics, if it the CBSD is willing to change the power level.

The CBSDs in the neighborhood respond, indicating if the responding CBSD is ok with the change of power level and the extent of power level change the responding CBSD is willing to accommodate. If all the CBSDs in the neighborhood agree to the change in power level, the SAS sends a message authorizing the CBSDs in the neighborhood to adjust the power level. If even a single CBSD responds indicating a refusal to change the power level, the SAS cannot authorize the change. However, the SAS can still arbitrate and command the CBSDs to change the power level of operation.

Requests can be initiated for at least the following: BTS CBSDs; CPE CBSD; CBSDs belonging to an ICG; and CBSDs belonging to a CCG.

The impact of change in power level takes time to stabilize. In some embodiments, a given CBSD is allowed to request for change in power level only once every within a predetermined time interval. In some embodiments, there is different time interval applied for CBSDs within a neighborhood that has just undergone a change in power level for the CBSDs of that neighborhood, within which those CBSDs are not to send out a request to SAS asking for a power level change. In some embodiments, these time intervals are in the order of minutes, and in some embodiments, hours. In some embodiments, they may be at most once or twice a day.

In some embodiments, there are several stages of the CBSD operation during registration/activation/post-activation with the SAS/CxM. The power level change can be performed at any time/step of the process. The associated IE exchanged between the CSDB/DP and SAS is defined below. In some embodiments, this process can be enabled through direct interactions across enterprise deployments exchanging information between CBSDs/DPs of the two neighboring deployments.

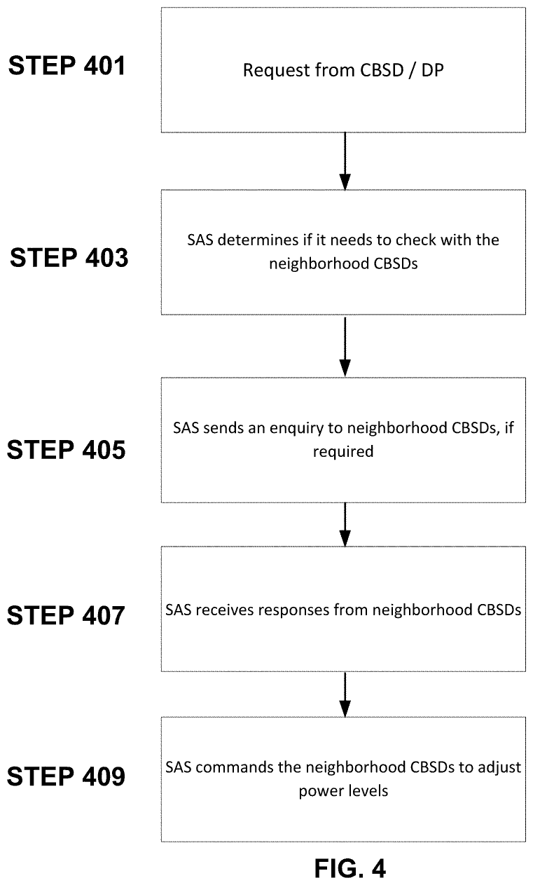

FIG. 4 is a simplified flowchart of events in accordance with some aspects of the disclosed method and apparatus. In a first step (STEP 401), a request is made from a CBSD/DP. The request is provided to a SAS. In a second step (STEP 403), the SAS determines if the SAS needs to check with neighborhood CBSDs. Next (STEP 405), the SAS sends an enquiry to neighborhood CBSDs, if required. In the following step (STEP 407) the SAS receives responses from neighborhood CBSDs. Finally (STEP 409), the SAS commands the neighborhood CBSDs to adjust power levels.

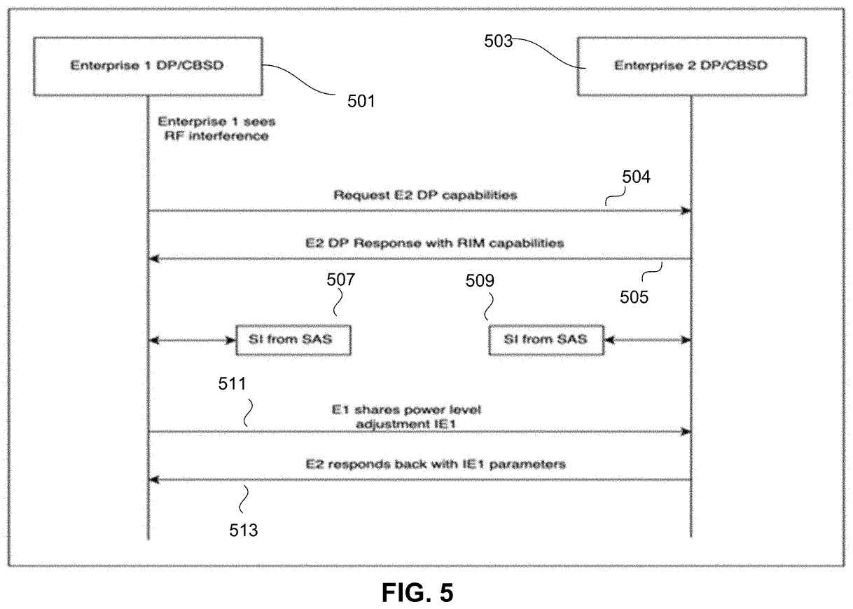

FIG. 5 is an illustration of a call flow in accordance with some embodiments of the disclosed method and apparatus. Initially, a CBSD 501 within a first Enterprise sees RF interference from at least a second Enterprise CBSD 503. The first Enterprise CBSD 501 initiates a procedure by sending a request 504 by which an enterprise domain proxy in each of the two Enterprise networks exchange capability information. The second Enterprise CBSD 503 sends back CBSD capability 505 if its willing to negotiate on power. If second Enterprise CBSD 503 agrees on power level negotiation then the CBSD 501 within a first Enterprise and second Enterprise CBSD 503 check spectrum and power from the respective SASs 507, 509. The second Enterprise CBSD 503 responds back with the Acknowledgement of power true 511. The second Enterprise CBSD 503 on the response object will have the power change response value 513. If the second Enterprise CBSD 503 sends no power level negotiation. Power level change needs to happen with the SAS.

The following is the request-response object for the initial message exchange between the two DPs.

Request- Response object for initial message
exchange between two domain-proxy

| IE/Group | | | IE Type and | Semantics |
|---|---|---|---|---|
| Name | Presence | Range | Reference | Description |
| CBSD ID | M | | STRING | |
| CBSD Capability | M | | STRING | |
| Operating power | O | | INTEGER | |
| Power Change | M | | INTEGER | |
| requested | | | | |
| UP/DOWN | M | | ENUMERATED | |
| Reason | M | | STRING | |

Request- Response object for power level negotiation

| | | | IE Type and | Semantics |
|---|---|---|---|---|
| IE/Group Name | Presence | Range | Reference | Description |
| CBSD ID | M | | STRING | |
| Acknowledgement | M | | BOOL | |
| of power | | | | |
| Power Change response | O | | INTEGER | |

### Enterprise 1 DP/CBSD with SAS Interaction

Operation

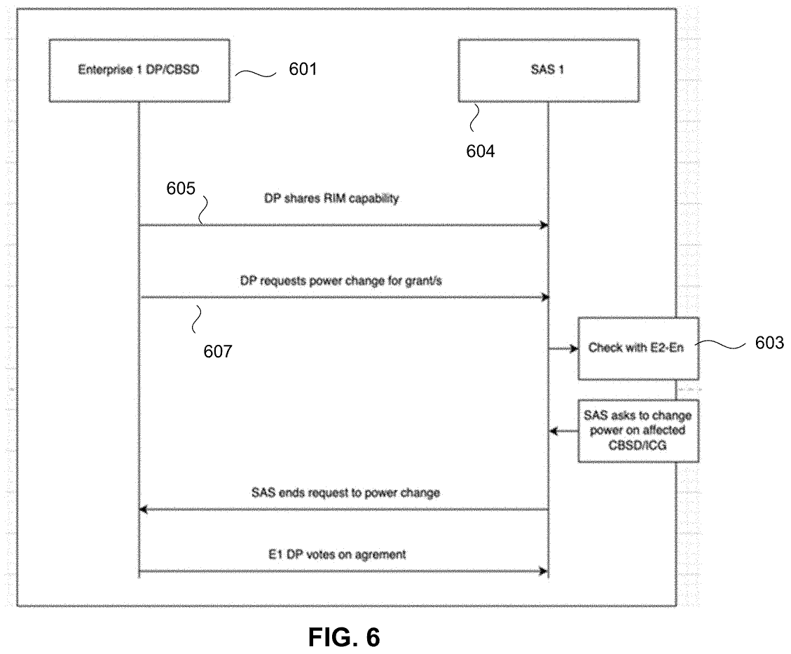

FIG. 6 is an illustration of a call flow for some embodiments of the disclosed method and apparatus. CBSD 601 within a first Enterprise sees RF interference from at least a second Enterprise EN 603. CBSD 601 within a first Enterprise initiates request for RF interference management from the SAS 604 on the next heartbeat message 605. CBSD 601 within a first Enterprise DP shares the grant power information's on request message 607. The SAS on heartbeat of other CBSDs or on CPAS cycle with other SAS vendors requests interference management. If second Enterprise EN 603 agrees on power level negotiation. Power level are changed on a heartbeat message with operation parameter change with power to be set. If second Enterprise EN 603 doesn't agree on power level negotiation. SAS can ask for channel reallocation or new grant for all the CBSDs on all the SASs.

### For Domain Proxy to SAS

Input - For CBSD only one object, for DP each CBSD ID will
send an array of these objects of the impacted channels

| | | | IE Type and | Semantics |
|---|---|---|---|---|
| IE/Group Name | Presence | Range | Reference | Description |
| CBSD ID | M | | STRING | |
| ICG/CCG | O | | ENUMERATED | |
| ICG/CCG group name | O | | STRING | |
| DP Capability | M | | STRING | |
| Interfering Grant ID | M | | STRING | |
| Power Change requested | M | | INTEGER | |
| Reason | M | | STRING | |

Output - This will be per CBSD

| IE/Group | | | IE Type and | Semantics |
|---|---|---|---|---|
| Name | Presence | Range | Reference | Description |
| CBSD ID | M | | STRING | |
| GRANT ID | M | | INTEGER | |
| Power set | M | | INTEGER | |

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
a) Determining interference is present to a first CBSD within a first CBRS; and
b) controlling parameters of a second CBSD within a second CBRS network to mitigate the interference presented to the first CBSD within the first CBRS.
